(19) United States
(12) Patent Application Publication
(10) Pub. No.: US 2015/0065605 A1
(43) Pub. Date: Mar. 5, 2015

(54) DUAL PURPOSE COATING

(71) Applicant: DEFLECTO, LLC, Indianapolis, IN (US)

(72) Inventors: Craig Malmloff, Fishers, IN (US); Patrick Jon Foley, Fishers, IN (US); Joseph C. Regula, Broadview Heights, OH (US); Robert Rafter, Dover, OH (US); Greg Rogers, Woodbury, TN (US); Shawn Maxwell, Memphis, TN (US)

(21) Appl. No.: 14/483,937

(22) Filed: Sep. 11, 2014

Related U.S. Application Data
(63) Continuation-in-part of application No. 14/017,086, filed on Sep. 3, 2013.

(51) Int. Cl. C09D 5/00

(52) U.S. Cl. CPC C09D 5/00
USPC 523/149

(57) ABSTRACT

A protective floor covering or desk pad comprising a body having an upper and lower planar surface and a copolymer resin coating on the lower planar surface.

### RELATED APPLICATION INFORMATION

The present invention(s) is a continuation-in-part of U.S. patent application Ser. No. 14/017,086, entitled “Dual Purpose Coating,” filed on Sep. 3, 2013 the entirety of the subject matter and the disclosure set forth therein are is incorporated herein by reference to the fullest extent permitted by law.

### FIELD OF THE INVENTION

The present invention(s) is directed to coatings for protective coverings that are effective to prevent the protective covering from shifting out of place on various underlying surfaces.

### BACKGROUND OF THE INVENTION

Protective mats for protecting flooring material from damage and wear are well known. Generally, protective mats consist of a flat panel made of a material that is suitable to prevent wear and tear on the underlying flooring material. In some instances, the protective mat may include studs or short spikes on the underside of the flat panel to hold the protective mat firmly in place on a textured flooring material such as carpeting. While protective mats with short spikes to prevent the protective mat from sliding or moving and improve the placement of a protective mat on textured flooring material, they are not suitable for use with relatively smooth flooring materials like wood or tiled floor.

Generally, protective mats with a smooth, non-studded bottom surface are used for smooth flooring like tile or hardwood. These flooring protection mats may have a non-slip coating on the bottom surface of the mat. However, these non-slip coatings are only effective on smooth surface flooring and do not prevent the flooring protection mat from slipping on textured floorings such as carpet and even lower pile carpets like commercial grade carpet.

Some attempts to provide a protective mat that is suitable for both smooth and textured surfaces have been made. For example, some protective mats employ felt backing and recessed studs to accommodate both a textured surface and a smooth surface. However, it has been found that the felt backing and recessed studs do not prevent the flooring protection mat from moving or slipping on textured surfaces like high pile carpet, medium pile carpet and commercial grade carpet. Accordingly, there is a need for a convertible protective mat that provides a protective barrier by covering an underlying surface regardless of its surface material and texture.

### SUMMARY OF THE INVENTION

The present disclosure provides one or more inventions that relate to a convertible protective floor covering or convertible floor mat or other substrate with a coating on the underside of the protective floor covering. The substrate of present invention could also be configured for use on many other surfaces, such as a desk or table, for example.

The coating on the underside of the protective floor covering serves as a friction device that is particularly ideal for use on both smooth and non-smooth or textured surfaces, including hard floor, commercial pile, low pile, medium pile carpet and high pile carpet.

Many coatings including components such as tacky adhesives, well known to persons of ordinary skill in the art, such as ethylene-vinyl acetate (“EVA”) or rubber were investigated by the inventors to find a suitable mixture to apply to a protective coating or covering to at least a portion of a substrate that can be used on multiple surfaces. One coating includes a copolymer with an ethylene-vinyl acetate component and the other coating is a rubber based compound coating. Each coating can include one or more additives well known to persons of ordinary skill in the art that allow the coating to bond to a surface and/or vary the coefficient of friction of the coating. Each coating can be applied to a surface or surfaces, or a portion of a surface or surfaces, of a protective covering or substrate by various methods known to person of ordinary skill in the art and allowed to cure. The resulting protective covering can be used on multiple surfaces with out worry of damage to the surface or worry of movement of protective covering with use.

A rubberized film such as neoprene, natural latex, or styrene butadiene latex is a suitable base component of the co polymer coating for use in connection with the present invention because it does not interact with the contact surface of the protective floor covering, or flooring surface, which otherwise could prevent the film from sticking to the surface, or allowing dirt or carpet fibers to adhere to the mat.

Additionally after further investigating, it was discovered that EVA, which has softness and flexibility like elastomers, but can be processed like thermoplastics is also an effective coating component and is a suitable replacement for rubberized film. Among other benefits of EVA, in it's cured state it has good stress-crack resistance, UV radiation resistance and waterproof properties. Additionally, when EVA is used there is no transfer of the adhesive coating to the underlying surface even after long term use. Finally, EVA is a cost effective material and can easily be applied and cured in the manufacturing process.

Additives such as tackfiers, plasticizers, and the like can be added to the EVA copolymer resin or rubberized film to increase the coefficient of friction of the coating and improve other coating characteristics such as adhesion, color, or clarity. The resulting mixture is applied to a surface or a portion of a surface of a protective floor covering with, for example, mechanical spray guns or a roller transfer system and allowed to cure for a time or dwell and at a temperature to remove all water from film in order to form a film or coating on the protective floor covering. These times and temperatures are well known to those of ordinary skill in the art.

One embodiment of the invention includes a coating and method for making coating for a surface of a protective floor covering that includes a copolymer of EVA. In embodiments of the invention, additives can be added to the coating to change performance characteristics of the coating. For example, in one embodiment of the invention, a catalyst can be blended or added to the EVA based coating. In another embodiment a plasticizer is blended or added to the copolymer resin. In another embodiment, a tackifier is blended or added to the copolymer resin. These additives can be added alone or in combination to the EVA based coating.

In another embodiment, the copolymer resin contains EVA in a wt % amount from and including 40-95%.

In other embodiments the copolymer resin can include Acrylic or Poly Vinyl Acetate (PVA) as a substitute for EVA or in combination with EVA.

Additionally, in another embodiment, the copolymer resin has a static coefficient of friction is from 1.0 to 1.10.

In other embodiments of the invention, the copolymer resin can be applied to a surface of a protective floor covering. For example, in one embodiment, the protective floor covering includes a body having an upper and lower planar surface and a copolymer resin coating on the lower planar surface.

Other embodiments of the invention include a method of making a coating for a surface of a protective floor covering including a copolymer resin. In some of these rubber based embodiments, the rubberized copolymer comprises at least one of copolymer resin selected from the group consisting of vinyl acrylic, vinyl acetate ethylene, polyureathane dispersions, styrene butadiene latex, styrene butadiene latex, neoprene latex, and natural rubber latex.

Additionally, additives can be added to the rubber based coating in various embodiments to change performance characteristics of the rubber based coating. For example, in another embodiment a catalyst is blended or added to copolymer resin. In another embodiment a plasticizer is blended or added to the copolymer resin. In another embodiment, a tacktifer is blended or added to the copolymer resin. In another embodiment, the copolymer resin contains rubber in a wt % from and including 1-20 wt %.

Additionally, in another embodiment, the copolymer resin has a static coefficient of friction is from 1.0 to 1.10.

In another embodiment of the invention a protective floor covering includes a body having an upper and lower planar surface and a copolymer resin coating on the lower planar surface.

Other systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts the protective floor covering with a coating being placed on a carpet.

FIG. 2 depicts a portion of a protective floor covering with the coating.

FIG. 3 depicts the protective floor covering with a coating being placed on a hard surface.

### DETAILED DESCRIPTION OF THE INVENTION

In accordance with the embodiments of the present invention, the present coating relates to protective floor coverings, and more particularly to protective floor coverings that are suitable on smooth and or textured surfaces.

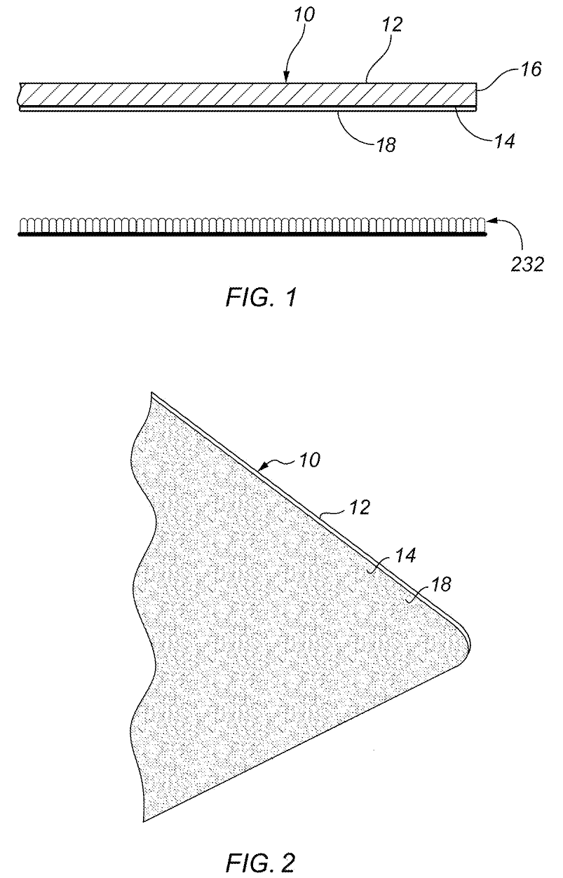

The protective floor covering as shown in FIG. 1 in an exlemplary embodiment includes a body 10 having upper and lower planar surfaces 12, 14, that are parallel to each other and are spaced from each other by an outermost perimeter edge 16 that extends entirely about the body 10. The coating is 18 is applied to the underside of the lower planar surface. The body 10 can be placed on a carpet 232 as a protective floor covering. The coating of present invention could be configured to work with virtually any size or shape of floor covering or substrate, including for example and without limitation non-planar substrates, multi-piece substrates such as slatted floor coverings, floor coverings having curved or irregular surfaces, and various other shapes and configurations which are known to those skilled in the art.

FIG. 2 depicts the protective floor covering that includes a body 10 having upper and lower planar surfaces 12, 14, that are parallel to each other and are spaced from each other by an outermost perimeter edge 16 that extends entirely about the body 10. The coating is 18 is applied to the underside of the lower planar surface 14. The planar surfaces can be smooth, relatively smooth or include various textures well known to those of ordinary skill in the art such as multiple planar surfaces, grooves, ribbing or dimples. The body 10 is of a generally uniform thickness and may be made of a material such as, but not limited to rubber, plastic, and/or the like, that is sufficiently durable to withstand wear and/or tear depending on and during use of for example the support of a chair on the upper surface 12 or lower surface 14 of the body 10. The body 10 may be made of a material that is transparent, translucent, opaque, and/or a combination thereof. The body 10 may have a pattern, for instance, on the lower surface 14 of the body, to form a design thereon. The body 10 may be made of a material that is transparent, translucent, opaque, and/or a combination thereof. The protective coating 16 can be applied to the lower planar surface 14 of the body.

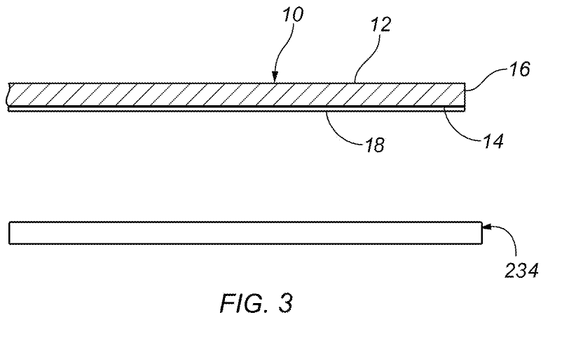

The protective floor covering as shown in FIG. 3 includes a body 10 having upper and lower planar surfaces 12, 14, that are parallel to each other and are spaced from each other by an outermost perimeter edge 16 that extends entirely about the body 10. The coating is 18 is applied to the underside of the lower planar surface. The body 10 can be placed on a smooth surface 24 as a protective floor covering.

In general, the Inventors found that each type of resin described below can be applied to the protective floor covering in order to obtain a protective floor covering that is suitable on smooth and or textured surfaces. One resin is includes EVA and the other resin includes rubber. Each of these resins can be provided on a surface to impart frictional resistance between the protective floor covering and the underlying surface. These coatings work on all surfaces and particularly well for protective floor coverings that are made of wood (either a solid composite or a flexible composite), plastic, glass, porous and non-porous surfaces because the coating adheres to the underlying respective surface of the protective floor covering and imparts frictional resistance.

The frictional resistance may be quantified by the static coefficient of friction of the coating. In order to provide frictional resistance between the protective floor covering and the underlying surface, the static coefficient of friction should be higher than static coefficient of friction of the underlying surface. In specific embodiments of each coating, the static coefficient of friction may be not tested and could be a pressure sensitive with no slip at any angle. A preferred range of static coefficient of friction for each resin is from 1.0 to 1.10 not tested >1.1> psa qualities <1.0< anti skid and harder film more slip.

In general, the EVA coating is a copolymer resin of a polymer having a branched or straight chain with a wide range of film formation temperatures and an amount of EVA sufficient to form a copolymer resin with a high coefficient of friction without causing the resulting copolymer resin to be pressure sensitive or transfer to a subsurface after initial use and extended use.

Specifically, as the amount of EVA wt % increases with respect to the copolymer resin wt %, the coefficient of friction increases. However, if the wt % of EVA is too high, it becomes difficult to remove the protective floor covering to which the copolymer coating has been applied to from the underlying surface i.e. carpeting or wood. If the wt % of EVA is too low, the protective floor covering cannot be used on varying surfaces. Thus, in order for the copolymer resin with EVA to be suitable for smooth and textured surfaces, the amount of EVA is preferably in a wt %, compared to the total wt % of the copolymer resin i.e. from and including 40 wt % to 95 wt %, 40 wt % to 60 wt %, and preferably 50 wt % to 60 wt %. Acrylics, Poly Vinyl Acetate and other similar compounds known by persons of ordinary skill in the art may also be used in place of or in combination with EVA in the copolymer resin.

The copolymer resin with a EVA can also contain other additives to improve overall characteristics of the coating. For example, any plasticizer known to those of ordinary skill in the art can be added in order to soften the coating, improve flexibility and durability of the EVA based coating. Plasticizers can include ester plasticizers such as esters of polycarboxylic acids with linear or branched chains and that may include aliphatic alcohol substituents, phthalate esters of straight chain and branched-chain alkyl alcohols, sebacates, adipates, terephthalates, dibenzoates, gluterates, phthalates, azelates, and other specialty blends or the like known to persons of ordinary skill in the art. Preferably, the coating can include BENZOFLEX 50 or dibutyl phthalate (DBP) as a plasticizer.

Additionally, pigments, which are well known to persons of ordinary skill in the art could be used to alter or enhance the coloring of the resulting coating. Fillers known to those of ordinary skill in the art can also be added to further improve performance or reduce production costs.

The a copolymer with an EVA component can also include a catalyst. The catalyst can be added to control the rates of polymerization and other reactions occurring within the copolymer resin. Suitable catalysts known to those of ordinary skill in the art can also be used to increase adhesion of the coating to the underlying surface of the protective floor covering and change the coefficient of friction of the coating.

The copolymer resin can also include an acrylic, Poly Vinyl Acetate or the like, instead of EVA. In this case, the copolymer resin includes acrylic or Poly Vinyl Acetate in an amount sufficient to form a copolymer resin with a high coefficient of friction without causing the resulting copolymer resin to be pressure sensitive or transfer to a subsurface after initial use and extended use. Acrylic or Poly Vinyl Acetate is preferably included in a wt % amounts from and including 40 wt %, to 90 wt %, 40 wt %, to 60 wt % and more preferably 50 wt %, to 60 wt % with respect to the total copolymer resin.

Further, the copolymer resin is not limited to just EVA, acrylic or Poly Vinyl Acetate but can comprise combinations of any of the foregoing. If combinations of acrylic, Poly Vinyl Acetate or EVA are used in the copolymer resin, the total wt % of the combined materials with respect to the total copolymer resin is from and including 40 wt % to 90 wt %, 40 wt %, to 60 wt % and more preferably 50 wt % to 60 wt %.

Several test were conducted on the copolymer resin with EVA to determine its suitability as a coating on a protective floor covering for different underlying surfaces compared to other protective floor coverings.

One such test conducted was the standard method for determining the static coefficient of friction for the coating. Specifically, the static coefficient of friction of Ceramic Tile and other like surfaces by the Horizontal Dynamometer pull meter method (ASTM C1028) was conducted to measure the static coefficient of friction of ceramic tile or other surfaces under various conditions. The ASTM C1028 test determines the static coefficient of friction by dragging the top surface across the lower surface while measuring the force to initiate the movement. Specifically, the top surface has a ten pound load to emulate usage by actual traffic and the lower surfaces were interchanged to develop static coefficient of friction values for various surfaces. Additional tests were conducted using water and other cleaning methods to determine the effect if any on the coefficient of friction between the chair mats and the substrate. In each instance exposure occurred within 30 seconds of the listed action below. After the test is conducted, measurements are calculated to determine the static coefficient of friction. A higher static coefficient of friction (“COP”) value indicates more slip resistance. Test samples were made of varying thickness PVC.

In this test, Comparative Example 1 was a protective floor covering with anchor bar studs and no adhesive coating. Comparative Example 2 was a protective floor covering with folded studs and no adhesive coating. Comparative Example 3 was a protective floor covering with conical studs and no adhesive coating. Comparative example 4 was a protective floor mat with no studs and no coating. Example 1 was a protective floor mat with an adhesive coating of a copolymer resin with EVA. The results of the testing over carpet, vinyl and wood surfaces are shown below in Tables 1 through 3.

TABLE 1
50 Ounce Cut Pile Carpet

| | Comparative | Comparative | Comparative | Comparative | |
|---|---|---|---|---|---|
| Test Mode | Ex. 1 | Ex. 2 | Ex. 3 | Ex. 4 | Example 1 |
| Dry | .92 | .88 | .86 | .94 | 3.56 |
| Wet-Distilled | .79 | .83 | .82 | .92 | 1.68 |
| Water | | | | | |
| Dish Detergent | .74 | .64 | .59 | .88 | 1.09 |
| Steam Mop | .70 | .69 | .49 | .92 | 1.39 |
| Spot Shot | .54 | .49 | .59 | .77 | .98 |
| Tested after | .91 | .84 | .84 | .91 | 2.47 |
| redried | | | | | |

TABLE 2
Sheet Vinyl (IVC)

| | Comparative | Comparative | Comparative | Comparative | |
|---|---|---|---|---|---|
| Test Mode | Ex. 1 | Ex. 2 | Ex. 3 | Ex. 4 | Example 1 |
| Dry | .29 | .32 | .29 | .26 | 1.46 |
| Wet-Distilled | .28 | .21 | .20 | .21 | .53 |
| Water | | | | | |
| Dish Detergent | .21 | .18 | .18 | .22 | .29 |
| Steam Mop | .25 | .24 | .21 | .20 | .36 |
| Spot Shot | .21 | .15 | .18 | .17 | .20 |
| Tested after | .29 | .29 | .28 | .25 | 1.12 |
| redried | | | | | |

TABLE 3
Engineered Wood Flooring

| | Comparative | Comparative | Comparative | Comparative | |
|---|---|---|---|---|---|
| Test Mode | Ex. 1 | Ex. 2 | Ex. 3 | Ex. 4 | Example 1 |
| Dry | .33 | .36 | .30 | .30 | 2.28 |
| Wet-Distilled | .21 | .18 | .17 | .17 | .83 |
| Water | | | | | |
| Dish Detergent | .20 | .17 | .17 | .17 | .46 |
| Steam Mop | .21 | .25 | .18 | .20 | .46 |
| Spot Shot | .17 | .16 | .15 | .17 | .22 |
| Tested after | .31 | .35 | .30 | .28 | .79 |
| redried | | | | | |

Based on the above test results, the copolymer resin with EVA showed a higher COF than the comparative samples over carpet, vinyl and wood surfaces. Furthermore, it is apparent that the same resin coating is suitable for multiple surfaces when compared to the comparative examples. This is evidenced by Comparative Example 1, which showed good COF for carpeting but was ineffective on smooth surfaces like vinyl or wood, while Example 1 showed good COF for each surface type tested, making the protective floor mat covering suitable for different underlying surfaces.

Testing was also conducted to determine the effect rolling traffic has on a particular flooring surface, In this test, known as the Phillips Roll Chair Test, the sample is subjected to the reciprocating action of a chair base having chair castors, which is loaded to 150 pounds total weight. The chair castors are set to cause a random cycling motion resulting in an oval shaped wear pattern. After a predetermined number of cycles, the test sample is given a numerical rating based on the general appearance and the movement of the chair mat is monitored from the original set point.

In the Phillips Roll Chair Test, Example 2 was a protective floor mat a protective floor mat with an adhesive coating of a copolymer resin with EVA. The results of the testing over varying carpet piles and laminate surfaces are shown below in Table 4.

TABLE 4

| | | | ″X″ | ″Y″ |
|---|---|---|---|---|
| | | | Direction | Direction |
| | | | Movement | Movement |
| | | | at 500 | at 500 |
| Cycles | Example 2 | Appearance Rating | cycles | cycles |
| 20,000 | 6 non Slip | Material showed very | 4.0 mm | 5.0 mm |
| | Material/ | slight cracking from | | |
| | Laminate | the heavy traffic. The | | |
| | Floor | soiled section showed | | |
| | | no indication of | | |
| | | adhesive transfer to | | |
| | | the flooring | | |
| 20,000 | 6 non slip | Material showed very | 5.5 mm | 6.0 mm |
| | material/ | slight cracking from | | |
| | pile | the heavy traffic. The | | |
| | carpeting | soiled section showed | | |
| | | no indication of | | |
| | | adhesive transfer to | | |
| | | the flooring | | |
| 20,000 | 6 Non Slip | Material showed very | 4.0 mm | 5.0 mm |
| | Material/ | slight cracking from | | |
| | Laminate | the heavy traffic. The | | |
| | Floor/Carpet | soiled section showed | | |
| | | no indication of | | |
| | | adhesive transfer to | | |
| | | the flooring | | |
| 20,000 | Reverse | Chair pad showed | 7 mm | 10 mm |
| | Coated/ | noticeable fracturing | | |
| | 35 oz Nylon | as a result of heavy | | |
| | Pile Cut | trafficking over the | | |
| | Carpet | carpet. The soiling | | |
| | | test completed on the | | |
| | | carpet test substrate | | |
| | | did not reveal any | | |
| | | adhesive transfer from | | |
| | | the chair pad to the | | |
| | | carpet surface | | |
| 20,000 | Reverse | Chair pad showed | 1 mm | 2 mm |
| | Coated/ | noticeable fracturing | | |
| | Laminate | as a result of heavy | | |
| | Floor | trafficking. The | | |
| | | soiling test completed | | |
| | | on the laminate test | | |
| | | substrate did not | | |
| | | reveal any adhesive | | |
| | | transfer from the chair | | |
| | | pad to the laminate. | | |

Based on the above test results, the copolymer resin with EVA showed minimal shifting and reduced wear on the protective floor covering on varying surfaces. This is evidenced by Example 2 which showed minimal movement in the “X” and “Y” directions on varying underlying surfaces making the protective floor mat covering suitable for different underlying surfaces for extended periods of use.

In general, the rubber coating has a formulation comprising a polymer with a wide range of film formation temperatures and an amount of rubber sufficient to form a copolymer resin with sufficient polyvinyl chloride to provide a high coefficient of friction without causing the resulting copolymer resin to be pressure sensitive.

In an embodiment, the copolymer resin containing rubber comprises at least one of vinyl acrylic, vinyl acetate ethylene and, polyureathane dispersions and styrene butadiene latex, styrene butadiene latex, neoprene latex, natural rubber latex. The copolymer resin can also comprise a combination of any vinyl acrylic, vinyl acetate ethylene, polyureathane dispersions, styrene butadiene latex, styrene butadiene latex, neoprene latex, and natural rubber latex and derivatives thereof. In various embodiments of the copolymer resin, the copolymer resin is present in a wt % amount from and including 1-20 wt %. Additionally, in various embodiments of the copolymer resin, rubber is present in a wt % amount from and including 75-95 wt %.

The copolymer resin with a rubber component is provided on a surface to impart frictional resistance between the protective floor covering and the underlying surface. The frictional resistance may be quantified by the static coefficient of friction of the copolymer resin.

In order to provide frictional resistance between the protective floor covering and the underlying surface, the static coefficient of friction should be higher than static coefficient of friction of the underlying surface. In specific embodiments, the static coefficient of friction may be not tested and could be a pressure sensitive with no slip at any angle. A preferred range of static coefficient of friction is from 1.0 to 1.10 not tested >1.1> psa qualities <1.0< anti skid and harder film more slip.

The copolymer resin with a rubber component can also contain other additives to improve overall characteristics of the coating. For example, any plasticizer known to those of ordinary skill in the art can be added in order to soften the coating. Some examples of suitable plasticizers include BENZOFLEX 50, DBP can be used and pigments could be used for colouring.

The copolymer resin with a rubber component can also include a catalyst. The catalyst can be added to control the rates of polymerization and other reactions occurring within the copolymer resin. Suitable catalysts known to those of ordinary skill in the art can also be used to increase adhesion to the surface of the floor mat covering, which can be made of PVC and lower coefficient of friction of the coating.

The method for applying each of the copolymer resins to the lower surface of the body is described below. Either copolymer resin can be applied to the lower surface of the body with mechanical spray guns or a roller transfer system. These methods are well known to persons of ordinary skill in the art. After application, the copolymer resin is cured at or near room temperature or higher for a time period in order to form a film or coating on lower surface of the body.

For example, the coatings may cure at 70 to 75° F. in 60 seconds or less. Curing is not limited to an ambient temperature and can occur at temperatures from 75° F. to 95° F. and above. The time period required for the coating to cure varies on the thickness coating and atmospheric conditions. For example, high humidity increases curing time. Similarly, thicker coatings will require a longer curing time from 2 to 3 minutes. As a result of the film or coating provided on the undersurface of the protective floor, the protective floor covering can be used on multiple surfaces with out worry of damage to the surface from studs or worry of movement of the protective floor covering with use.

The coating is not limited to the underside surface of a protective floor matting, it can be applied to other protective coverings, or surfaces where an anti-slip function is needed, for example desk mats, mouse pads, place mats, drink coasters, desk storage containers or the like

The amount of the copolymer resin coated onto the lower surface of the body will vary depending on the desired application. For example, where a higher friction, non-slip property of the coating is needed, a greater amount of the copolymer resin is applied to the lower surface. If a lower friction, non-slip property of the coating is needed, a lesser amount of the copolymer resin is applied to the lower surface. Generally, the amount of copolymer resin applied to the lower surface of the body is such that the friction provided by the coating permits the protective floor covering to be used on a generally smooth surface, e.g., hardwood, tile, slate, linoleum, concrete, and/or the like, and textured surfaces like low pile, medium pile, high pile and commercial grade carpeting without the use of suds or spikes. In this manner, the user can avoid damaging the smooth surface and/or textured surface with only one protective floor covering.

To further illustrate various illustrative embodiments of the present inventions, the coating can be made of vinyl acrylic, vinyl acetate ethylene, and styrene butadiene latex, combinations or derivatives thereof.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed is:

1. A method of making a slip resistant protective covering comprising the steps of:
providing a copolymer resin that comprises ethylene-vinyl acetate; and
applying the copolymer resin to at least a portion of a surface of the covering.

3. The method according to claim 1 further comprising adding or blending a plasticizer to the copolymer rein.

4. The method according to claim 2 further comprising adding a tacktifer.

5. The method according to claim 1 wherein the copolymer resin has a static coefficient of friction is from 1.0 to 1.10.

6. A protective floor covering or desk pad comprising:
a body having an upper surface and a lower surface; and
a copolymer resin comprising ethylene-vinyl acetate coating on at least a portion of the lower planar surface.

8. The copolymer resin protective coating according to claim 6 wherein the copolymer resin includes a plasticizer.

9. The copolymer resin protective coating according to claim 6 wherein the copolymer resin includes a tacktifer.

10. The copolymer resin protective coating according to claim 6 wherein the copolymer resin has a static coefficient of friction is from 1.0 to 1.10.
